(19) United States
(12) Patent Application Publication
(10) Pub. No.: US 2007/0241531 A1
(43) Pub. Date: Oct. 18, 2007

(54) Stem assembly for a bicycle

(75) Inventors: Christopher P. D'Aluisio, Watsonville, CA (US); Mark Schroeder, San Jose, CA (US)

Correspondence Address: MICHAEL BEST & FRIEDRICH LLP, 100 E WISCONSIN AVENUE, Suite 3300, MILWAUKEE, WI, 53202, US

(73) Assignee: Specialized Bicycle Components, Inc., Morgan Hill, CA (US)

(21) Appl. No.: 11/405,781

(22) Filed: Apr. 18, 2006

(51) Int. Cl. B62K 21/00

(52) U.S. Cl. 280/279

(57) ABSTRACT

A stem assembly for a bicycle that includes a handlebar and a fork having a steerer. The fork is coupled to a wheel and is rotatable about a steering axis to turn the wheel. The stem assembly includes a stem that has a steerer aperture configured to receive the steerer and a handlebar receiving portion configured to receive the handlebar. A wedge is at least partially disposed within the steerer aperture and partially surrounds the steerer aperture. The wedge includes a tapered surface that defines an angle between the steering axis and the stem.

### BACKGROUND

The present invention relates to stem assemblies for bicycles, and more particularly to stem assemblies that include an angularly adjustable stem.

Bicycles generally include a front fork that is coupled to a front wheel and the fork is rotatable to turn the front wheel. A stem is commonly coupled to the fork, opposite the wheel. The stem attaches to the fork at one end of the stem and supports handlebars at the opposite end. The handlebars provide a place for a rider to place his or her hands during a ride, and the handlebars can be rotated to rotate the stem, fork and front wheel. For several reasons, such as the height of the rider, riding conditions, comfort, etc., the rider may desire to change the location of the handlebars relative to the rider. One way of doing this is to replace the stem or handlebar with a different stem or handlebar.

Another method of changing the location of the handlebars is to use an adjustable stem that allows the user to adjust an angle of the stem with respect to the fork. Adjusting the angle of the stem with respect to the fork can raise or lower the handlebars, or move the handlebars closer to or further from the rider.

### SUMMARY

The present invention provides a stem assembly for a bicycle including a handlebar and a fork having a steerer. The stem assembly includes a stem including a steerer aperture configured to receive the steerer and a handlebar receiving portion configured to receive the handlebar. A wedge is at least partially disposed within the steerer aperture, and the wedge partially surrounds the steerer aperture and includes a tapered surface that defines an angle between the steering axis and the stem. Preferably, the wedge can be positioned in either a first orientation to define a first angle between the steering axis and the stem or a second orientation to define a second angle between the steering axis and the stem.

In one embodiment, the wedge is part of clamp configured to couple the stem to the steerer. For example, the clamp could include a fastener and first and second clamp members, such that the fastener is operable to move the first and second clamp members to force the wedge further into the steerer aperture to apply pressure to the steerer.

In another embodiment, the wedge is a first wedge, and the stem assembly further includes a second wedge positioned in the steerer aperture generally opposite the first wedge. In this embodiment, the first and second wedges cooperatively define the angle between the steering axis and the stem. The first and second wedges can be positioned in either a first orientation to define a first angle between the steering axis and the stem or a second orientation to define a second angle between the steering axis and the stem.

The present invention also provides a bicycle stem assembly including a stem having a steerer aperture having a cross-section including a generally cylindrical portion and an elongated portion. The assembly further includes a wedge at least partially disposed within the steerer aperture (e.g., in the elongated portion). The wedge includes a tapered surface that defines an angle between the steering axis and the stem. As with the previously-described embodiment, the wedge can be positioned in either a first orientation or a second orientation to change the angle between the steering axis and the stem. In addition, as with the previously-described embodiment, the wedge can be part of a clamp that secures the stem relative to the steerer.

In the above-described embodiment, the assembly can further comprise a cap including a cap aperture and a cap adjustment member at least partially received by the cap aperture. A fastener is positioned through the cap aperture and the cap adjustment member, and the fastener is configured to couple the cap and the stem to the steerer. The cap adjustment member is configured to be positioned in either a first orientation when the wedge is in the first orientation or a second orientation when the wedge is in the second orientation.

The present invention also discloses a method of manufacturing a stem for a bicycle, the stem including a steerer receiving portion and a handlebar receiving portion. The method comprises arranging at least one layer of material within a mold to at least partially define the stem and an aperture in the material, positioning an air bladder through the aperture and into the mold, inflating the air bladder, curing the at least one layer of material within the mold to at least partially form the stem, removing the stem from the mold, removing the air bladder through the aperture, and coupling an insert to the steerer receiving portion to block at least a portion of the aperture.

Other aspects of the invention will become apparent by consideration of the detailed description and accompanying drawings.

### BRIEF DESCRIPTION OF THE DRAWINGS

FIG. 1 is a side view of a bicycle including a stem assembly embodying the present invention.

FIG. 2 is an exploded view of the stem assembly of FIG. 1 and a portion of the bicycle of FIG. 1.

FIG. 3 is a cross-section of the stem assembly and a portion the bicycle of FIG. 1 with the stem assembly in a first orientation.

FIG. 4 is a cross-section of the stem assembly and a portion of the bicycle of FIG. 1 with the stem assembly in a second orientation.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

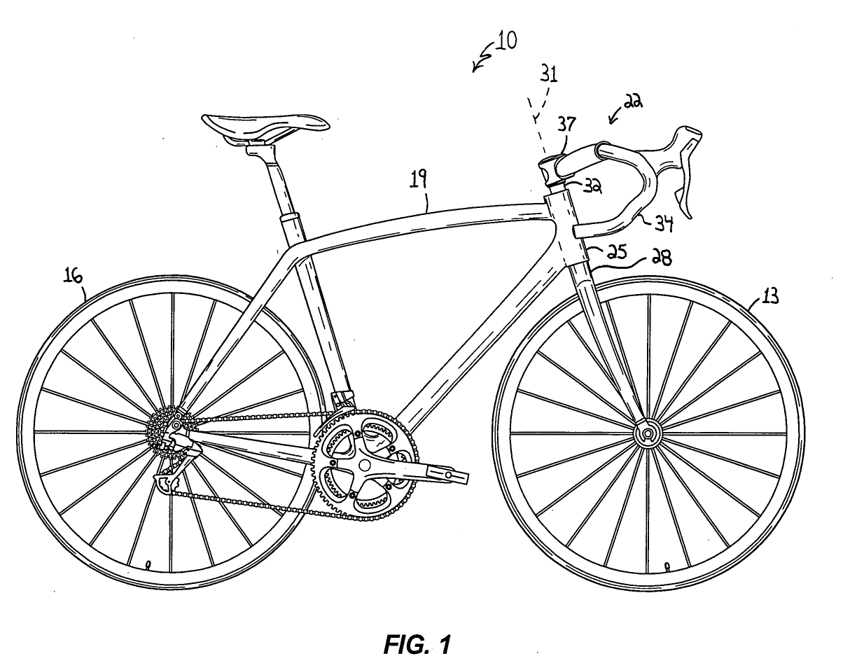

FIG. 1 illustrates a bicycle 10 that includes a front wheel 13, a rear wheel 16, a frame 19, and a steering assembly 22. The frame 19 includes a head tube 25 that engages and supports a front fork 28 for pivotal movement about a steering axis 31. The front fork 28 includes a steerer 32 that extends through and above the head tube 25 to provide an attachment point for the steering assembly 22. The front fork 28 also supports the front wheel 13 of the bicycle 10 such that movement of the steering assembly 22 produces a corresponding movement of the front fork 28 and the front wheel 13.

The steering assembly 22 includes a handlebar 34 and a stem assembly 37. While the illustrated handlebar 34 is a drop bar, one of ordinary skill in the art will realize that virtually any bar style could be employed with the present invention, such as a bar utilized by mountain or off-road bikes that can be generally straight. The handlebar 34 can be formed from a composite material, such as a carbon/epoxy composite, with other materials also being suitable for use (e.g., plastics, metals, other composites, and the like).

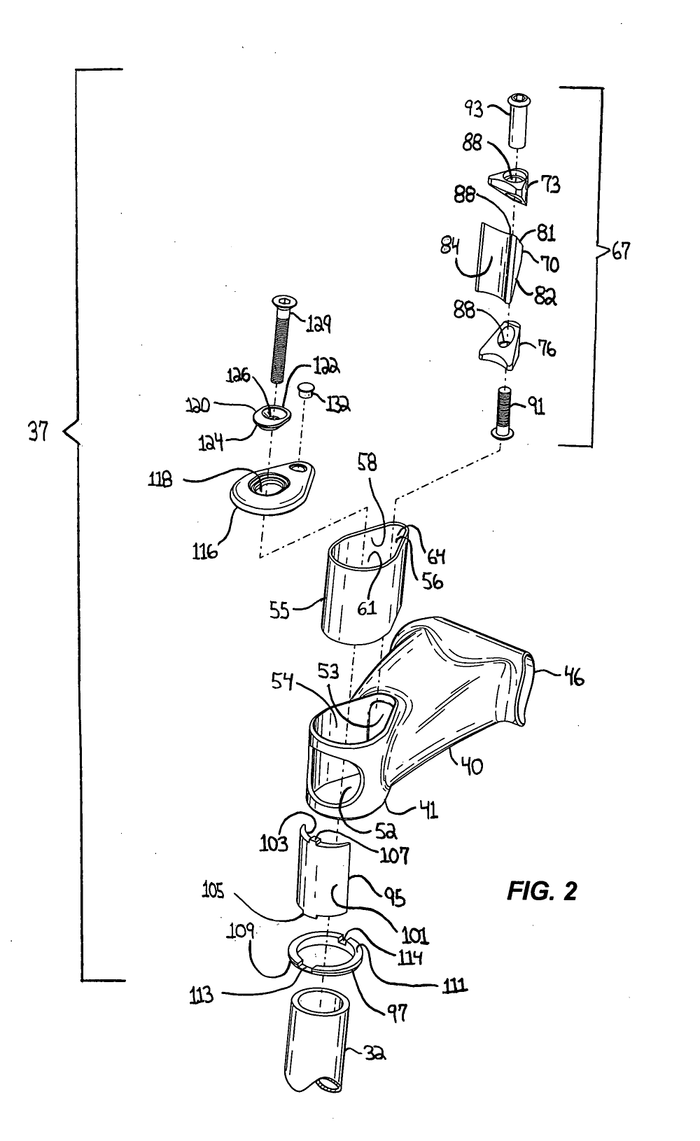

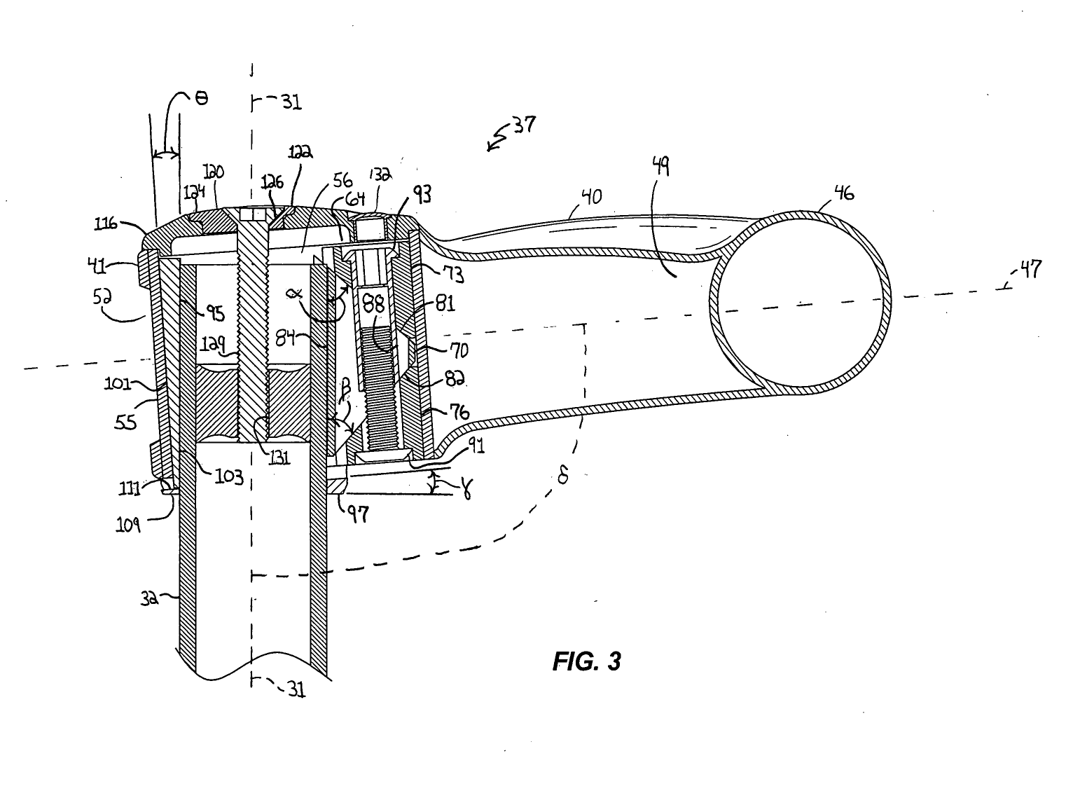

Referring to FIGS. 2 and 3, the stem assembly 37 includes a stem 40 that has a steerer receiving portion 41 and a handlebar receiving portion 46. A stem axis 47 is defined by a line that extends generally through the center of the stem 40 as illustrated in FIG. 3. The illustrated stem 40 is formed from a composite material such as a carbon/epoxy composite. Of course other materials (e.g., plastics, fiberglass composite, KEVLAR composite, or other composites, and the like) could also be employed to form the stem 40. In other constructions, the stem 40 can be formed from metals, such as steel, aluminum, titanium, metal alloys, and the like.

The illustrated stem 40 is formed by arranging at least one layer of prepreg composite material (i.e., fiber material impregnated with a partially-cured adhesive, such as epoxy) in a desired orientation within a mold. An inflatable air bladder is positioned within the mold to define an interior space 49 of the stem 40 (FIG. 3). The prepreg material is positioned around the air bladder such that the prepreg material defines a bladder aperture 52 through the steerer receiving portion 41 at the rear of the stem 40. The bladder aperture 52 defines the path through which the bladder exits the mold.

Once all the materials are positioned as desired, the mold is closed, the mold is heated, and the bladder is expanded to pressurize the prepreg material. The bladder pushes the materials against the inside of the mold to achieve the desired shape of the stem 40. The stem is then cured to form a single integrated part that is removed from the mold. The air bladder is removed from the interior space 49 through a front aperture 53 and the rear aperture 52. If desired, the stem 40, including the rear and front bladder apertures 52, 53 can be machined, sanded, or ground.

While in the method described above, the air bladder is removed from the interior space 49 through the rear aperture 52, in other methods of manufacturing the stem, the air bladder can be removed through the front aperture 53 and then through an aperture 54 defined by the steerer receiving portion 41. If such a method is utilized, the rear aperture 52 can be omitted. However, removing the air bladder through the rear aperture 52 allows for the use of generally thinner tooling for molding the stem than tooling utilized when the air bladder is removed through the aperture 54. The thinner tooling allows for a relatively faster cure time of the adhesive, which saves time when manufacturing the stem. In yet other constructions, the air bladder can be removed from the front of the stem (i.e., near the handlebar receiving portion 46). Therefore, the front aperture 53 and the rear aperture 52 can be omitted. In such constructions, the stem will typically include a clamp or other suitable device to couple the handlebar 34 to the stem 40. Whereas in the illustrated construction, the handlebar 34 is integrally formed with the stem 40 as described in U.S. patent applications Ser. Nos. 11/084,351 and 11/083,907 both filed on Mar. 18, 2005, the entire contents of which are herby incorporated by reference.

In some constructions, the interior space 49 is filled with a filler material. For example, plastic or foam can be positioned or injected into the space 49 to change some of the mechanical properties of the stem 40 without significantly increasing the weight of the stem 40. In still other constructions, a core, such as a honeycomb core is positioned within the interior space 49 as the stem 40 is formed.

Referring to FIGS. 2 and 3, an insert 55 is bonded to the inside of the steerer receiving portion 41 to define a steerer aperture 56 and to block or cover the rear aperture 52 and the front aperture 53. By covering the rear and front bladder apertures 52, 53, the insert 55 provides additional strength to the steerer receiving portion 41 and provides a more aesthetically pleasing appearance. The insert 55 can be formed from any suitable material, such as a carbon/epoxy composite, plastics, metals, fiberglass composite, KEVLAR composite, or other composites, and the like. In such a construction, the insert 55 can be molded using compression molding and steel tooling to control the dimensions of the insert 55. In yet other constructions, the stem 40 may omit the insert 55, and in such constructions the aperture 54 of the steerer receiving portion 41 defines the steerer aperture 56. Such constructions may omit the insert 55 because the stem may not include the rear and front bladder apertures 52, 53. The stem may not include the rear and front bladder apertures 52, 53 if the stem is formed from metals, such as steel, aluminum, titanium, metal alloys, and the like, or if the air bladder is removed from the front of the stem (i.e., near the handlebar receiving portion 46).

Referring to FIG. 2, the insert 55 has vertical inner walls 58 that define the steerer aperture 56. The illustrated steerer aperture 56 is in the shape of a teardrop and includes a cylindrical portion 61 and an elongated portion 64. It should be understood that the teardrop-shaped steerer aperture 56 is just one possible shape of the steerer aperture, and in other constructions the steerer aperture can take other suitable shapes.

With continued reference to FIG. 2, the stem assembly 37 also includes a clamp 67. The illustrated clamp 67 includes a wedge 70 disposed between two clamp members 73, 76. The wedge 70 has two tapered surfaces 81, 82 and a steerer-engaging surface 84. The steerer-engaging surface 84 forms a partial cylinder that has a radius of curvature approximately the same as a radius of curvature of an outside surface of the steerer 32. Furthermore, the wedge 70 and clamp members 73, 76 are shaped to relate to the elongated portion 64 of the steerer aperture 56, such that when the clamp 67 is placed within the elongated portion 64 of the steerer aperture 56, the clamp 67 and steerer aperture 56 together define an aperture that is generally cylindrically shaped, similar to the steerer 32. It should be understood that the illustrated shape of the elongated portion 64 and the wedge 70 and clamp members 73, 76 is just one possible shape. In other constructions, the elongated portion 64 and the wedge 70 and clamp members 73, 76 can take other suitable shapes so long as when the clamp 67 is placed within the steerer aperture 56 an aperature generally the shape of the outside surface of the steerer 32 is formed.

Referring to FIG. 3, the tapered surfaces 81, 82 of the wedge 70 are angled with respect to the steerer receiving surface 84. An angle α is defined by the taper of the tapered surface 81 with respect to the steerer receiving surface 84, and an angle β is defined by the taper of the tapered surface 82 with respect to the steerer receiving surface 84. In the illustrated construction, the angles α and β differ by approximately 8 degrees are complimentary.

Referring to FIG. 2 and 3, the wedge 70 and the clamp members 73, 76 each include a clamp aperture 88 that extends longitudinally therethrough. The clamp apertures 88 receive a fastener system that includes a threaded stud 91 and a threaded binder nut 93. The binder nut 93 receives the stud 92 to couple the wedge 70 between the clamp members 73, 76. While in the illustrated construction the binder nut 93 extends through the clamp member 73 and the threaded stud 91 extends through the clamp member 76, in other constructions the fastener system can be inverted such that the threaded stud 91 extends through the clamp member 73 and the binder nut 93 extends through the clamp member 76. In yet other constructions, the binder nut can be press fit within the clamp aperture 88 of one of the clamp members 73, 76 to fix the binder nut to one of the clamp members 73, 76. Therefore, the binder nut is unable to rotate with respect to the clamp members 73, 76.

The illustrated stem assembly 37 also includes another wedge, in the form of a shim 95, and a spacer 97. The illustrated shim 95 forms a partial cylinder with an outer surface 101 having a radius of curvature approximately equal to a radius of curvature of the inner wall 58 of the insert 55 at the cylindrical portion 61. An inner surface 103 of the shim 95 is tapered with respected to the outer shim surface 101 to define a shim taper angle θ. The shim taper angle θ relates to the taper angles α, ⊕ of the surfaces 81, 82 of wedge 70, and in the illustrated construction the shim taper angle θ is approximately 4 degrees. In other constructions the taper of the shim 95 can range from about 0 degrees to about 20 degrees to relate to the tapered surface of the wedge 70. In the illustrated construction, because the taper angles α, β are complimentary, generally θ=½ (α−β). In other constructions, the taper angles α, β, θ may have other suitable relationships.

Referring to FIG. 2, the shim 95 includes a first alignment tab 105 that extends from a first end of the shim 95, and a second alignment tab 107 that extends from a second end of the shim 95. In the illustrated construction, the first shim alignment tab 105 has a first size and the second shim alignment tab 107 has a second size, different than the first size.

Referring to FIGS. 2 and 3, the spacer 97 includes a bottom surface 109 and a top surface 111. The top surface 111 is tapered at an angle γ with respect to the bottom surface 109. The taper angle γ of the spacer 97 relates to the taper angle θ of the shim 95 and the taper angles α, β of the surfaces 81, 82 of the wedge 70. The taper angle γ of the illustrated spacer 97 is approximately 4 degrees, and in other constructions the taper angle γ of the spacer 97 can range from about 0 degrees to about 20 degrees to match the taper of the shim 95 and the surfaces 81, 82 of the wedge 70. While in the illustrated construction, the taper angle γ of the spacer 97 is approximately equal to the taper angle θ of the shim 95, in other constructions the taper angle γ of the spacer 97 may differ from the taper angle θ of the shim 95.

The spacer 97 also includes first and second alignment notches 113, 114. The first alignment notch 113 is sized to receive the first shim alignment member 105 and the second alignment notch 114 is sized to receive the second shim alignment member 107. While the illustrated alignment members 105, 107, 113, 114 include tabs and notches, it should be understood that any suitable alignment mechanism can be used, such as markings, lines, or matching colors. In yet other constructions, the spacer and shim may omit the alignment members. For example, if the taper angles of the shim and spacer are approximately 0 degrees, the shim and spacer may omit the alignment members.

With continued reference to FIG. 2 and 3, the stem assembly 37 also includes a cap 116. The illustrated cap 116 is in the shape of teardrop, similar to the upper end of the steerer aperture 56. The cap 116 receives the steerer receiving portion 41 of the stem 40 to enclose the steerer aperture 56.

The cap 116 includes a cap aperture 118 that receives and supports an adjustment member 120. The adjustment member 120 is elongated and includes a first end 122 and a second end 124. An adjustment aperture 126 extends through the adjustment cap 116, and the illustrated aperture 126 is located closer to the first end 122 than to the second end 124 to relate to the taper angles of the shim 95, the spacer 97, and the surfaces 81, 82 of the wedge 70, as described below in more detail. The adjustment member aperture 126 is sized to receive a fastener 129 that extends through the cap 116 and the adjustment member 120, into a threaded bore 131 of the steerer 32 to couple the stem 40 to the steerer 32. In other constructions, the stem assembly 37 may omit the adjustment member 120. In such constructions, the adjustment aperture 126 can be located through the cap 116, and the adjustment aperture 126 can be formed at an angle through the cap to relate to the taper angles of the shim 95, the spacer 97, and the surfaces 81, 82 of the wedge 70. For small taper angles, such as approximately 1 degree for the shim taper angle θ, the adjustment aperture can be formed generally normal through the cap 116.

In one construction, the cap 116 is formed from a carbon/epoxy composite, fiberglass composite, KEVLAR composite, or other composites, and the like, while the adjustment member 120 is stamped or machined from a metal, such as steel, aluminum, titanium, metal alloys, and the like.

Referring to FIG. 3, a clamp fastener cap 132 is located at the front of the cap 116 and is generally aligned with the binder nut 93 of the clamp fastener system. The fastener cap 132 provides a protective and aesthetically-pleasing cover for the binder nut 93. The fastener cap 132 can be removed to permit access to the binder nut 93.

Referring to FIGS. 1, 2 and 3, to assemble the stem assembly 37, the spacer 97 is placed around the steerer 32 such that the first spacer alignment notch 113 is position toward the rear of the steerer 32. As is understood by one of ordinary skill in the art, typically, the bottom surface 109 of the spacer 97 rests against an upper bearing assembly (not shown) of the bicycle 10. In the illustrated construction, the bottom surface 109 of the spacer 97 is generally normal to the steerer axis 31 to facilitate preloading the upper bearing assembly. Furthermore, while the illustrated construction illustrates only a single spacer 97, in other constructions, the stem assembly 37 can include two, three or more spacers, as is known in the art. For example, in one construction two or three spacers, with no taper (i.e. the top surface is parallel to the bottom surface), can be placed between the spacer 97 and the upper bearing assembly or the head tube 25.

With continued reference to FIGS. 2 and 3, the shim 95 is set into place such that the inner surface 103 of the shim 95 partially surrounds and contacts the steerer 32, and the first shim alignment tab 105 engages the first spacer alignment notch 113. The stem 40 (with the insert 55 bonded in place) is then positioned over the steerer 37 and shim 45 such that the steerer 37 and shim 95 are received into the steerer aperture 56 of the stem 40. Next, the clamp 67 is vertically received through of the elongated portion 64 of the steerer aperture 56. Referring to FIG. 3, the clamp 67 is arranged such that the tapered surface 81 of the wedge 70 is generally upwardly facing while the tapered surface 82 is generally downwardly facing.

The cap 116 is placed on top of the steerer receiving portion 41 to generally enclose the steerer aperture 56. The cap adjustment member 120 is set within the cap aperture 118 with the first end 122 of the adjustment member 120 generally forwardly facing (as shown in FIGS. 2 and 3). The fastener 129 is inserted through the adjustment member aperture 126 and into the threaded bore 131 of the steerer 37. The adjustment member 120 is arranged with the first end 122 forwardly facing in order that the adjustment aperture 126 and fastener 129 are aligned with the threaded bore 131.

As is understood by one of ordinary skill in the art, the fastener 129 can be tightened or loosed to adjust a preload on the upper bearing assembly. Once the desired bearing preload has been achieved. Hex head wrenches, or other suitable devices, can then be used to tighten the nut 93 and stud 91 of the clamp 67 to couple the stem 40 to the steerer tube 32. As the nut 93 and the stud 91 are tightened (i.e. rotated in a clockwise direction) the clamp members 73, 76 will move closer together, and as a result the tapered surfaces 81, 82 of the wedge 70 will slide along tapered surfaces of the clamp members 73, 76 to force the wedge 70 against the steerer 32 while the clamp members 73, 76 are forced against the insert 55. With the cap 116 in the position illustrated in FIG. 3, the clamp fastener cap 132 can be removed and the nut 93 can be tightened or loosened without removing the cap 116 (i.e., the bearing preload remains constant by not having to rotate the fastener 129).

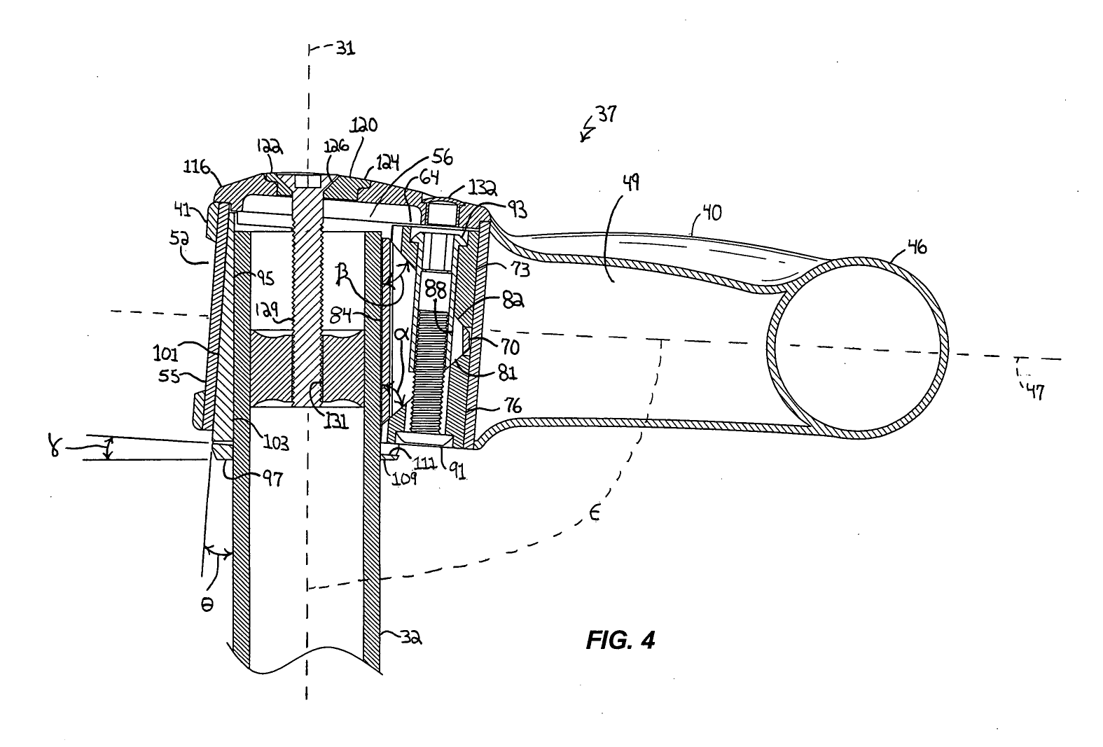

With the wedge 70, the shim 95, the spacer 97, and the cap adjustment member 120 in the orientations illustrated in FIG. 3, and as described above, an angle δ is defined between the steering axis 31 and the stem axis 47. In the illustrated embodiment, this angle δ is 94 degrees, and the angle δ is approximately equal to 90 degrees plus the taper angle θ of the shim 95. Referring to FIG. 4, by re-orientating the wedge 70, the shim 95, the spacer 97, and the cap adjustment member 120, a second angle E is achieved between the steering axis 31 and the stem axis 47.

Referring to FIGS. 2 and 4, to achieve the second angle ε, the stem assembly 37 is disassembled in generally reverse order as the assembly process described above. Then the stem assembly 37 is re-assembled using generally the same steps described above with the exceptions that the wedge 70, the shim 95, the spacer 97, and the cap adjustment members 120 are placed in second orientations, that are rotated 180 degrees from the orientation described above. In the illustrated embodiment, this second angle ε is 86 degrees, and the angle ε is approximately equal to 90 degrees minus the taper angle θ of the shim 95.

More specifically, the spacer 97 is rotated 180 degrees about the steering axis 31 such that the second alignment notch 114 is located generally at the rear of the steerer 32 (i.e. the top surface 111 tapers downward from the rear of the steerer 32 toward the front). The shim 95 is inverted from the position illustrated in FIG. 3, such that the second alignment tab 107 engages the second alignment notch 114. The wedge 70 similarly is inverted such that the tapered surface 82 upwardly facing while the tapered surface 81 is downwardly facing. The cap adjustment member 120 is rotated 180 degrees about the steering axis 31 such that the second end 124 of the adjustment member 120 is generally facing toward the front of the bicycle 10 and so that the aperture 126 is aligned with the threaded bore 131 of the steerer 32. The fasteners 91, 93, and 129 can be tightened or loosened, as described above, to achieve the desired bearing pre-load and clamping force.

Comparing FIGS. 3 and 4, the angles δ, ε differ by approximately 8 degress, which is determined by the tapers of the shim 95, the spacer 97, and the surfaces 81, 82 of the wedge 70. In other constructions, the angles δ, ε can differ from approximately 0 degrees to about 40 degrees. To achieve angles δ, ε that differ by amounts other than 8 degrees only the shim 95, the wedge 70, the spacer 97, and the cap adjustment member 120 would need to be replaced. The stem assembly 37 can be provided to the user with multiple sets of shims, wedges, spacers, and cap adjustment members that correspond to other angle differences (i.e., 2, 3, 4, 5, 6, 7, 8, 9 degrees, etc . . . ). The remaining components of the stem assembly (i.e. the stem, cap, clamp members, fasteners, etc . . . ) can be used with the other sets of shims, wedges, spacers, and cap adjustment members. In one construction, the components that are reused are formed from composite materials, such as a carbon/epoxy composite, fiberglass composite, KEVLAR composite, or other composites, and the like, while the components that are replaced for the different angles are formed from less expensive materials, such as metal, which may include steel, aluminum, titanium, metal alloys, and the like.

Thus, the invention provides, among other things, a stem assembly 37 that includes a stem 40 that is angularly adjustable relative to the steering axis 31. Various features and advantages of the invention are set forth in the following claims.

What is claimed is:

1. A stem assembly for a bicycle including a handlebar and a fork having a steerer, the fork coupled to a wheel and rotatable about a steering axis to turn the wheel, the stem assembly comprising:
a stem including a steerer aperture configured to receive the steerer and a handlebar receiving portion configured to receive the handlebar; and
a wedge at least partially disposed within the steerer aperture, the wedge partially surrounding the steerer aperture and including a tapered surface that defines an angle between the steering axis and the stem.

2. The stem assembly of claim 1, wherein the wedge is configured to be positioned in one of a first orientation to define a first angle between the steering axis and the stem and a second orientation to define a second angle between the steering axis and the stem, the first angle different than the second angle.

3. The stem assembly of claim 1, wherein the wedge comprises a portion of a clamp configured to couple the stem to the steerer.

4. The stem assembly of claim 3, wherein the clamp is vertically received within the steerer aperture.

5. The stem assembly of claim 3, wherein the clamp includes a fastener and first and second clamp members, and wherein the fastener is operable to move the first and second clamp members to force the wedge further into the steerer aperture.

6. The stem assembly of claim 1, wherein the wedge is a first wedge, the stem assembly further comprising a second wedge positioned in the steerer aperture generally opposite the first wedge, and wherein the first and second wedges cooperatively define the angle between the steering axis and the stem.

7. The stem assembly of claim 6, wherein the first and second wedges are configured to be positioned in one of a first orientation to define a first angle between the steering axis and the stem and a second orientation to define a second angle between the steering axis and the stem, the first angle different than the second angle.

8. The stem assembly of claim 1, wherein at least a portion of the stem is formed from a composite material, and wherein at least a portion of the handlebar receiving portion being formed around a portion of the handlebar such that the handlebar and the stem are integrated into a single component.

9. A stem assembly for a bicycle including a handlebar and a fork having a steerer, the fork coupled to a wheel and rotatable about a steering axis to turn the wheel, the stem assembly comprising:
a stem including,
a steerer aperture configured to receive a portion of the steerer and having a cross-section including a generally cylindrical portion and an elongated portion; and
a handlebar receiving portion configured to receive the handlebar;
a wedge at least partially disposed within the steerer aperture and including a tapered surface that defines an angle between the steering axis and the stem.

10. The stem assembly of claim 9, wherein the wedge is positioned in the elongated portion of the steerer aperture.

11. The stem assembly of claim 9, wherein the wedge comprises a portion of a clamp.

12. The stem assembly of claim 11, wherein the clamp further includes a fastener operable to couple the stem to the steerer, the stem assembly further comprising a cap including a cap aperture, the cap configured to substantially enclose an opening of the steerer aperture, and wherein the fastener is accessible through the cap aperture.

13. The stem assembly of claim 9, wherein the wedge is configured to be positioned in one of a first orientation to define a first angle between the steering axis and the stem and a second orientation to define a second angle between the steering axis and the stem, the first angle different than the second angle.

14. The stem assembly of claim 13, further comprising:
a cap including,
a cap aperture; and
a cap adjustment member at least partially received by the cap aperture;
a fastener positioned through the cap aperture and the cap adjustment member, the fastener configured to couple the cap and the stem to the steerer, and wherein the cap adjustment member is configured to be positioned in one of a first orientation when the wedge is in the first orientation and a second orientation when the wedge is in the second orientation.

15. The stem assembly of claim 9, wherein the wedge is a first wedge, the stem assembly further comprising a second wedge acting on the steerer tube generally opposite the first wedge, and wherein the first and second wedges cooperatively define the angle between the steering axis and the stem.

16. The stem assembly of claim 15, further comprising a third wedge at least partially surrounding the steerer and located between the stem and a head tube of the bicycle, and wherein the first, second, and third wedges cooperatively define the angle between the steering axis and the stem.

17. A stem assembly for a bicycle including a handlebar and a fork having a steerer, the fork coupled to a wheel and rotatable about a steering axis to turn the wheel, the stem assembly comprising:
a stem including a steerer aperture configured to receive the steerer and a handlebar receiving portion configured to receive the handlebar;
a first wedge; and
a second wedge, the first and second wedges at least partially disposed within the steerer aperture and acting on the steerer generally opposite one another, and wherein the first and second wedges cooperatively define an angle between the steering axis and the stem.

18. The stem assembly of claim 17, wherein the first and second wedges are configured to be positioned in one of a first orientation to define a first angle between the steering axis and the stem and a second orientation to define a second angle between the steering axis and the stem.

19. The stem assembly of claim 17, wherein the steerer aperture is a generally elongated cylinder steerer aperture configured to receive a portion of the steerer.

20. The stem assembly of claim 19, wherein the first wedge comprises a portion of a clamp configured to couple the stem to the steerer, and wherein the clamp is vertically received within the steerer aperture.

21. A method of manufacturing a stem for a bicycle, the stem including a steerer receiving portion and a handlebar receiving portion, the method comprising:
arranging at least one layer of material within a mold to at least partially define the stem and an aperture in the material;
positioning an air bladder through the aperture and into the mold;
inflating the air bladder;
curing the at least one layer of material within the mold to at least partially form the stem;
removing the stem from the mold;
removing the air bladder through the aperture; and
coupling an insert to the steerer receiving portion to block at least a portion of the aperture.

22. The method of manufacturing a stem for a bicycle of claim 21, further comprising:
arranging at least one layer of material within a mold to at least partially define the insert; and
curing the at least one layer of material within the mold to at least partially from the insert.
